(19) United States
(12) Patent Application Publication
(10) Pub. No.: US 2003/0224280 A1
(43) Pub. Date: Dec. 4, 2003

(54) Process for lowering charge/mass ratio of toner particles having controlled morphology and containing quaternary ammonium tetraphenylborate charge control agents

(76) Inventors: Matthew C. Ezenyilimba, Walworth, NY (US); John C. Wilson, Rochester, NY (US); Gretchen S. McGrath, Rochester, NY (US)

Correspondence Address: JAECKLE FLEISCHMANN & MUGEL, LLP, Suite 200, 39 State Street, Rochester, NY, 14614-1310, US

(21) Appl. No.: 10/414,394

(22) Filed: Apr. 15, 2003

Related U.S. Application Data
(63) Continuation of application No. 09/814,899, filed on Mar. 22, 2001, now abandoned.

(51) Int. Cl. C08J 3/00; G03G 9/08

(52) U.S. Cl. 430/137.14; 430/108.2; 430/108.21; 430/108.22

(57) ABSTRACT

A process for lowering the charge/mass (Q/m) ratio of toner particles formed by limited coalescence includes: forming an organic phase containing a water-immiscible liquid, pigment, a quaternary ammonium tetraphenylborate salt, and a polymeric material selected from the group consisting of an acrylic resin, a methacrylic resin, a styrene-acrylic resin, a styrene-methacrylic resin, a polyamide, and a polyester. The organic phase is dispersed in an aqueous phase containing a solid colloidal stabilizer, and a suspension of small droplets of the organic phase is formed in the aqueous phase by high shear agitation. The water-immiscible liquid is removed from the small droplets, thereby forming a suspension in the aqueous phase of small, non-spherically shaped solid particles, which are separated from the aqueous phase and dried. The quaternary ammonium tetraphenylborate salt is included in the organic phase in an amount effective for lowering the charge/mass (Q/m) ratio of the toner particles.

### CROSS-REFERENCE TO RELATED APPLICATION

This application is a continuation of application Ser. No. 09/814,899, filed Mar. 22, 2001 for METHOD FOR FORMING TONER PARTICLES HAVING CONTROLLED MORPHOLOGY AND CONTAINING QUATERNARY AMMONIUM TETRAPHENYLBORATE CHARGE CONTROL AGENTS.

This application is also related to commonly assigned application Ser. No. 09/814,923, filed Mar. 22, 2001 for METHOD FOR FORMING TONER PARTICLES HAVING CONTROLLED MORPHOLOGY AND CONTAINING A QUATERNARY AMMONIUM TETRAPHENYLBORATE AND A POLYMERIC PHOSPHONIUM SALT, now U.S. Pat. No. 6,416,921, issued Jul. 9, 2002, the disclosure of which is incorporated herein by reference.

### FIELD OF THE INVENTION

The present invention relates to polymeric powders suitable for use as electrostatographic toners and, more particularly, to a process for lowering the charge/mass ratio of electrostatographic toner particles comprising one or more quaternary ammonium tetraphenylborate charge control agents that further operate to control the morphology of the toner particles.

### BACKGROUND OF THE INVENTION

Electrostatic toner polymer particles are commonly prepared by a process referred to as “limited coalescence”. In this process, polymer particles having a narrow size distribution are obtained by forming a solution of a polymer in a solvent that is immiscible with water, dispersing the solution so formed in an aqueous medium containing a solid colloidal stabilizer and removing the solvent by evaporation. The resultant particles are then isolated, washed and dried.

In the practice of this technique, toner particles are prepared from any type of polymer that is soluble in a water-immiscible solvent. Thus, the size and size distribution of the resulting particles can be predetermined and controlled by the relative quantities of the particular polymer employed, the solvent, the quantity and size of the water insoluble solid particulate suspension stabilizer, typically silica or latex, and the size to which the solvent-polymer droplets are reduced by agitation.

Limited coalescence techniques of this type have been described in numerous patents pertaining to the preparation of electrostatic toner particles because such techniques typically result in the formation of toner particles having a substantially uniform size distribution. Representative limited coalescence processes employed in toner preparation are described in U.S. Pat. Nos. 4,833,060 and 4,965,131, the disclosures of which are incorporated herein by reference

The shape of the toner particles has a bearing on electrostatic toner transfer and cleaning properties. Thus, for example, the transfer and cleaning efficiency of toner particles have been found to improve as the sphericity of the particles are reduced. Thus far, workers in the art have long sought to modify the shape of the evaporative limited coalescence type toners independently of pigment, binder, or charge agent choice in order to enhance the cleaning and transfer properties of the toner.

U.S. Pat. No. 5,283,151 is representative of the prior art in this field and described the use of carnauba wax to modify toner morphology. The method comprises the steps of dissolving carnauba wax in ethyl acetate heated to a temperature of at least 75° C. and cooling the solution, resulting in the precipitation of the wax in the form of very fine needles a few microns in length; recovering the wax needles and mixing them with a polymer material, a solvent, a charge control agent, and, optionally, a pigment to form an organic phase; dispersing the organic phase in an aqueous phase comprising a particulate stabilizer and homogenizing the mixture; and evaporating the solvent and washing and drying the resultant product.

This technique, however, requires the use of elevated temperature to dissolve the wax in the solvent, followed by cooling the solution to precipitate the wax. The wax does not stay in solution in ethyl acetate at ambient temperature, which makes scale-up of this method very difficult.

Tetraphenylborate quaternary salts have been employed as charge control agents for electrophotographic toners. For example, U.S. Pat. Nos. 5,194,472 and 5,516,616 disclose quaternary ammonium salt charge control agents, including tetraphenylborates, that contain ester moieties. U.S. Pat. Nos. 5,075,190 and 5,041,625 disclose mono- and bis-pyridinium tetraphenylborate charge control agents, and U.S. Pat. No. 5,482,741 describes a process for absorbing a charge control agent such as potassium tetraphenylborate onto flow aid particles. Also, JP 91-41021 discloses an image-forming method using a toner containing various kinds of tetraarylborates as charge control agents. However the use of tetraphenylborate quaternary ammonium salts in the limited coalescence process to control the charge/mass ratio of the resulting toner particles is not known.

### SUMMARY OF THE INVENTION

The present invention is directed to a process for lowering the charge/mass (Q/m) ratio of toner particles formed by limited coalescence. The process comprises: forming an organic phase comprising a water-immiscible liquid, pigment, a quaternary ammonium tetraphenylborate salt, and a polymeric material selected from the group consisting of an acrylic resin, a methacrylic resin, a styrene-acrylic resin, a styrene-methacrylic resin, a polyamide, and a polyester. The organic phase is dispersed in an aqueous phase containing a solid colloidal stabilizer, and a suspension of small droplets of the organic phase is formed in the aqueous phase by high shear agitation. The water-immiscible liquid is removed from the small droplets, thereby forming a suspension in the aqueous phase of small, non-spherically shaped solid particles, which are separated from the aqueous phase and dried.

The quaternary ammonium tetraphenylborate salt, which is included in the organic phase in an amount effective for lowering the charge/mass (Q/m) ratio of the toner particles, is selected from the group consisting of salts represented by the general formulas (I), (II), (III), and (IV), and mixtures thereof:

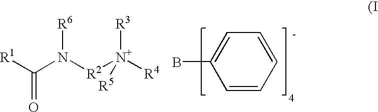

wherein R¹ represents a substituted or unsubstituted alkyl or aryl group; R² represents an alkylene or arylene group; R³, R⁴, and R⁵ independently represent a substituted or unsubstituted alkyl group, and R³ and R⁴ taken together may form a cyclic ring system; and R⁶ represents hydrogen or a substituted or unsubstituted alkyl group;

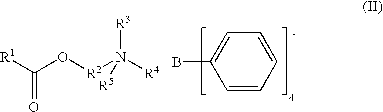

wherein R¹ represents a substituted or unsubstituted alkyl or aryl group; R² represents an alkylene or arylene group; R³, R⁴ and R⁵ each independently represents a substituted or unsubstituted alkyl group; and R³ and R⁴ taken together may form a cyclic ring system;

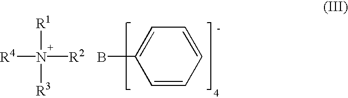

wherein R¹, R², R³ and R⁴ each independently represents an alkyl or substituted alkyl group, and R¹ and R² taken together may form a cyclic ring system;

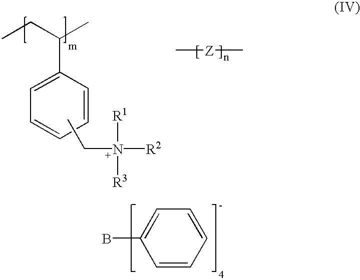

wherein R¹, R² and R³ each independently represents an alkyl or substituted alkyl group and R¹ and R² taken together may form a cyclic ring structure; Z, if present, represents at least one monomer copolymerizable with a monomer comprising a tetraphenylborate salt substituent; m and n represent the weight percentages in a polymerization mixture of, respectively, the monomer comprising a tetraphenylborate salt substituent and Z, m and n together totaling 100.

### DETAILED DESCRIPTION OF THE INVENTION

The present invention, a novel process in which quaternary ammonium tetraphenylborate salts are introduced into the organic phase of a limited coalescence process, overcomes limitations of the prior art. The inclusion of quaternary ammonium tetraphenylborate salts in the organic phase controls the charge/mass ratio of the resulting non-spherically shaped toner particles formed upon the removal of the organic solvent. Toner morphology is thereby controlled independently of the toner composition components (resin, binder matrix, pigment, etc.). Toner particles produced by the process of the present invention have a volume-average particle size preferably of about 3.5μ to about 5μ.

Further in accordance with the present invention, the pigment can be provided as a dispersion prepared by conventional techniques such as, for example, media milling, melt dispersion and the like. The pigment dispersion, polymeric material, quaternary ammonium tetraphenylborate salt, water-immiscible liquid, and, optionally, an additional charge control agent are combined to form an organic phase in which the pigment concentration ranges from about 1 to about 40 weight percent, preferably about 4 to about 20 weight percent, based upon the total weight of solids. The optional charge control agent is employed in an amount up to about 10 weight percent, preferably about 0.2 to about 5 weight percent, based on the total weight of solids. Suitable charge control agents are disclosed, for example, in U.S. Pat. Nos. 3,893,935, 4,323,634, and 4,079,014, and British Patent No. 1,420,839.

The water-immiscible liquid chosen for use in the organic phase steps may be selected from among any of the well-known solvents capable of dissolving polymers of the type employed herein. Typical of the solvents chosen for this purpose are dichloromethane, ethyl acetate, methyl ethyl ketone, and the like.

The organic phase is permitted to stir, typically overnight, then dispersed in an aqueous phase comprising a particulate stabilizer and, optionally, a promoter. The aqueous phase has a pH of, preferably, about 2 to about 7 and, more preferably, is buffered to a pH of about 4.

The particulate stabilizer selected for use herein may be selected from silicon dioxide or from highly cross-linked polymeric latex materials of the type described in the previously mentioned U.S. Pat. No. 4,965,131. Silicon dioxide is preferred and is generally used in an amount ranging from about 1 to about 15 weight percent, based on the total solids employed. The size and concentration of the stabilizer particles determine the size of the final toner particles: the smaller the size and/or the higher the concentration of such particles, the smaller the size of the final toner particles.

Any suitable promoter that is water soluble and affects the hydrophilic/hydrophobic balance of the solid dispersing agent in the aqueous solution may be employed in order to drive the solid dispersing agent, that is, the particulate stabilizer, to the polymer/solvent droplet-water interface. Typical of such promoters are sulfonated polystyrenes, polyesteramides, alginates, carboxymethyl cellulose, tetramethylammonium hydroxide or chloride, 2-(diethylamino)ethyl methacrylate, water-soluble complex resinous amine condensation products of ethylene oxide, urea and formaldehyde, and polyethyleneimine. Also effective for this purpose are gelatin, casein, albumin, gluten and the like, or non-ionic materials such as methoxycellulose. The promoter is generally used in an amount from about 0.2 to about 0.6 parts per 100 parts of aqueous solution.

Various additives generally present in electrostatographic toner may be added to the polymer prior to dissolution in the solvent or in the dissolution step itself, such as waxes and lubricants.

The mixture of organic and aqueous phases is subjected to homogenization, preferably by high shear agitation at ambient temperature, whereby the particulate stabilizer forms an interface between the organic globules in the aqueous phase. Due to the high surface area associated with small particles, the coverage by the particulate stabilizer is not complete. Coalescence continues until the surface is completely covered by particulate stabilizer. Thereafter, no further growth of the particles occurs. Accordingly, the amount of the particulate stabilizer is inversely proportional to the size of the toner obtained. The relationship between the aqueous phase and the organic phase, by volume may range from about 1:1 to about 9:1. This indicates that the organic phase is typically present in an amount from about 10% to about 50% of the total homogenized volume. Following the homogenization treatment, the organic solvent present is evaporated and the resultant product washed and dried.

The present invention is applicable to the preparation of polymeric toner particles from any type of polymer that is capable of being dissolved in a solvent that is immiscible with water and includes compositions such as, for example, olefin homopolymers and copolymers such as polyethylene, polypropylene, polyisobutylene polyisopentylene, ethylene-methyl acrylate copolymers, ethylene-ethyl acrylate copolymers, ethylene-ethyl methacrylate copolymers, and ethylene-allyl alcohol copolymers; polytrifluoroolefins such as polytetrafluoroethylene and polytrifluorochloroethylene; polyamides such as poly(hexamethylene adipamide), poly(hexamethylene sebacamide), and polycaprolactam; acrylic and methacrylic resins such as poly(methyl methacrylate), poly(methyl acrylate), and poly(ethyl methacrylate); styrene homopolymers and copolymers such as polystyrene, styrene-acrylic and styrene-methacrylic resins, for example, styrene-butyl acrylate and styrene-methyl methacrylate copolymers; cellulose derivatives; polyesters; and polyvinyl resins. Preferred polymers include acrylic, methacrylic, styrene-acrylic, and styrene-methacrylic resins, polyamides, and polyesters, styrene-acrylic resins such as styrene butyl acrylate being particularly preferred.

Pigments suitable for use in the practice of the present invention should be insoluble in water but capable of being dispersed in the polymer, and should yield strong permanent color. Typical of such pigments are organic pigments such as phthalocyanines, lithols, and the like, and inorganic pigments such as TiO₂, carbon black, and the like. Examples of the phthalocyanine pigments include copper phthalocyanine, monochlor copper phthalocyanine, and hexadecachlor copper phthalocyanine. Other suitable organic pigments include anthraquinone vat pigments such as vat yellow 6GLCL1127, quinone yellow 18-1, indanthrone CL1106, pyranthrone CL1096, brominated pyranthrones such as dibromopyranthrone, vat brilliant orange RK, anthramide brown CL1151, dibenzanthrone green CL 1101, flavanthrone yellow CL1118; azo pigments such as toluidine red C169 and hansa yellow; and metallized pigments such as azo yellow and permanent red. The carbon black may be any of the known types such as channel black, furnace black, acetylene black, thermal black, lamp black and aniline black. The pigments are employed in an amount sufficient to give a content thereof in the toner from about 1 to about 40 weight percent, preferably about 4 to about 20 weight percent, based on the weight of the toner.

The quaternary ammonium tetraphenylborate salt are included in the organic phase in an amount equal to about 0.1 to about 10 weight percent, preferably about 0.5 to about 5 weight percent, of total solids. Preferred quaternary ammonium tetraphenylborate salts useful in the practice of the present invention are represented by the general formulas (I), (II), (III), and (IV), as described below:

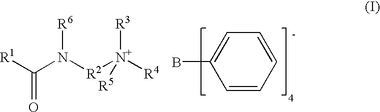

where R¹ represents a substituted or unsubstituted alkyl or aryl group; R² represents an alkylene or arylene group; R³, R⁴, and R⁵ independently represent a substituted or unsubstituted alkyl group; and R³ and R⁴ taken together may form a cyclic ring system; and R⁶ represents hydrogen or an alkyl group. Examples of R¹ include methyl, ethyl, n-propyl, n-butyl, hexyl, undecyl, heptadecyl, benzyl, phenyl, 4-methylphenyl, 4-t-butylphenyl, and the like. Examples of R² include ethylene, 1,3-propylene, 1,4-butylene, hexamethylene, p-phenylene, and the like. Examples of R³, R⁴, and R⁵ include methyl, ethyl, n-propyl, octadecyl, benzyl, and the like, and R³ and R⁴ taken together may be 1,4-butylene, 1,5-pentylene, and the like. Examples of R⁶ include hydrogen, methyl, ethyl, n-propyl, n-butyl, octadecyl, benzyl, and the like. Preferably, R¹ is undecyl, R² is 1,3-propylene, R³ is methyl, R⁴ is methyl, R⁵ is benzyl and R⁶ is hydrogen.

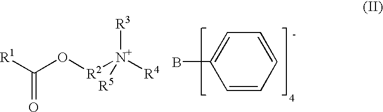

where R¹ represents a substituted or unsubstituted alkyl or aryl group; R² represents an alkylene or arylene group; R³, R⁴ and R⁵ each independently represents a substituted or unsubstituted alkyl group; and R³ and R⁴ taken together may form a cyclic ring system. Examples of R¹ include methyl, ethyl, n-propyl, n-butyl, hexyl, undecyl, heptadecyl, benzyl, phenyl, 4-methylphenyl, 4-t-butylphenyl, and the like. Examples of R² include ethylene, 1,3-propylene, 1,4-butylene, hexamethylene, p-phenylene, and the like. Examples of R³, R⁴ and R⁵ include methyl, ethyl, n-propyl, octadecyl, benzyl, and the like, and R³ and R⁴ taken together may be 1,4-butylene, 1,5-pentylene, and the like. Preferably, R¹ is undecyl or phenyl, R² is 1,3-propylene, R³ is methyl, R⁴ is methyl, and R⁵ is benzyl.

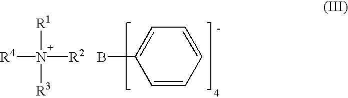

where R¹, R², R³ and R⁴ each independently represents an alkyl or substituted alkyl group, and R¹ and R² taken together may form a cyclic ring system. Examples of R¹, R², R³ and R⁴ include methyl, ethyl, n-propyl, isopropyl, n-butyl, t-butyl, pentyl, hexyl, 2-ethylhexyl, heptyl, octyl, decyl, octadecyl, benzyl, 2-naphthylmethyl, and the like. Examples of R¹ and R² taken together include 1,4-butylene, 1,5-pentylene, and the like. Preferably, R¹ and R² are methyl, R³ is octadecyl, R⁴ is 2-naphthylmethyl.

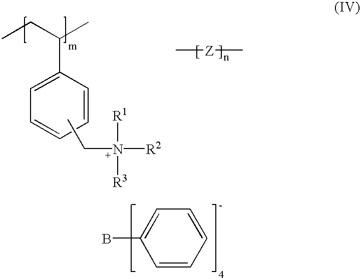

where R¹, R² and R³ each independently represents an alkyl or substituted alkyl group and R¹ and R² together may form a cyclic ring structure. Examples of R¹, R², and R³ include methyl, ethyl, n-propyl, isopropyl, n-butyl, iso-butyl, t-butyl, octyl, octadecyl, benzyl, and the like. Preferably, R¹ is octadecyl, R² is methyl, and R³ is methyl.

The vinylbenzyl moiety may be any of the ortho, meta or para isomers alone or in combination. Weight percents of monomeric components in the feed are represented by m and n, which total 100, with m having a value from 0.01 to 100 weight percent. Preferably, m is about 10 and n is about 90.

Z is any copolymerizable monomer residue and may include more than one comonomer. Suitable comonomers include isobutyl methacrylate, isobutyl acrylate, methyl methacrylate, methyl acrylate, styrene, 4-t-butylstyrene, methyl vinyl ether, acrylamide, methacrylamide, and the like. Preferably, Z is isobutyl methacrylate,

Tables 1 and 2 contain structures of representative compounds of the general formulas (I) and (II), respectively. Table 3 lists structures of representative compounds of the general formula (III). In Table 4 are depicted structures of representative polymeric compounds of the general formula (IV).

TABLE 1

| | |
|---|---|
| | I |
| 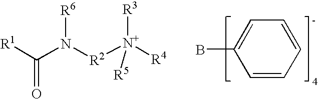 | |

| Compound | R¹ | R² | R³ | R³ | R⁵ | R⁶ |
|---|---|---|---|---|---|---|
| 1 | C₁₁H₂₃ | CH₂CH₂CH₂ | CH₃ | CH₂C₆H₅ | CH₃ | H |
| 2 | C₁₁H₂₃ | CH₂CH₂CH₂ | CH₃ | CH₃ | CH₃ | H |
| 3 | C₅H₁₁ | CH₂CH₂CH₂ | CH₃ | CH₂C₆H₅ | CH₃ | H |
| 4 | C₁₁H₂₃ | CH₂CH₂ | CH₃ | CH₂C₆H₅ | CH₃ | H |

TABLE 2

| | |
|---|---|
| | II |
| 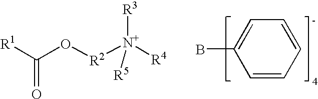 | |

| Compound | R¹ | R² | R³ | R⁴ | R⁵ |
|---|---|---|---|---|---|
| 5 | C₁₁H₂₃ | CH₂CH₂ | CH₃ | CH₂C₆H₅ | CH₃ |
| 6 | C₁₁H₂₃ | CH₂CH₂ | CH₃ | CH₃ | CH₃ |
| 7 | C₁₁H₂₃ | CH₂CH₂CH₂ | CH₃ | CH₂C₆H₅ | CH₃ |
| 8 | C₆H₅ | CH₂CH₂CH₂ | CH₃ | CH₃ | CH₃ |
| 9 | C₆H₅ | CH₂CH₂CH₂ | CH₃ | CH₂C₆H₅ | CH₃ |

TABLE 3

| | |
|---|---|
| | (III) |
| 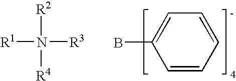 | |

| Compound | R¹ | R² | R³ | R⁴ |
|---|---|---|---|---|
| 10 | CH₃ | CH₃ | C₁₈H₃₇ | CH₂C₆H₅ |
| 11 | CH₃ | CH₃ | C₁₈H₃₇ | C₁₈H₃₇ |
| 12 | CH₃ | CH₃ | C₁₈H₃₇ | 2-naphthyl- |
| | | | | CH₂ |

TABLE 4

| | | | | | | | | (IV) |
|---|---|---|---|---|---|---|---|---|
| 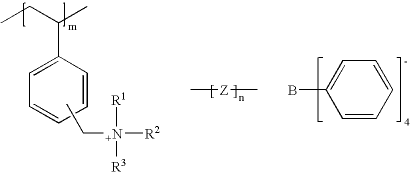 | | | | | | | | |
| | | | | | m | n | | |
| Compound | R¹ | R² | R³ | Z | (wt %) | (wt %) | IV(DCM) | Tg, C |
| | | | | 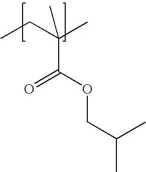 | | | | |
| 13 | CH₃ | C₁₈H₃₇ | CH₃ | | 10 | 90 | 0.66 | 59.5 |
| 14 | CH₃ | CH₂C₆H₅ | CH₃ | | 10 | 90 | 0.45 | 67.5 |
| 15 | CH₃ | C₄H₉ | CH₃ | | 10 | 90 | 0.55 | 66.6 |
| 16 | CH₃ | C₈H₁₇ | CH₃ | | 10 | 90 | 0.48 | 65.4 |

The polymers listed in Table 4 above are presumed to include the monomeric units in substantially the same weight ratio (m:n) as was present in the feed mixture,

### SYNTHESIS EXAMPLES

Preparation of N-(3-Dimethylaminopropyl) Lauramide

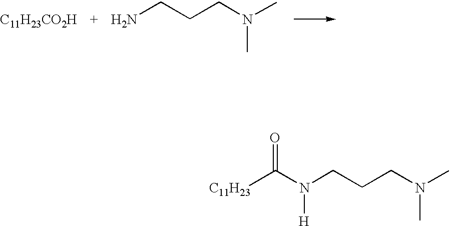

A mixture of 1000.0 g (5.0 mol) of lauric acid and 510.2 g (5.0 mol) of 3-dimethylaminopropylamine was placed in a 3-necked 2 liter flask equipped with a blade stirrer and Vigreaux column with takeoff head. The mixture was heated with stirring in an oil bath over a 2.42 hour period while gradually increasing the bath temperature to 219° C. and collecting the water condensate. The mixture was placed on oil pump vacuum for 15 min to remove any remaining water and cooled. The yield of product was 1346.4 g (94.7% of theory).

Preparation of N,N-Dimethyl-N-(3-lauramidopropyl)-N-benzylammonium Chloride

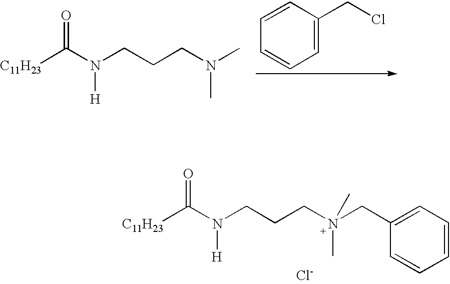

A solution of 116.38 g (0.409 mol) of N-(3-dimethylaminopropyl)lauramide and 51.79 g (0.409 mol) of benzyl chloride in 500 ml of acetone was stirred at room temperature for 48 hrs. The solution was concentrated to a viscous oil. The yield of product was 167.2 g (99.4% of theory).

Anal. Calcd. For C₂₄H₄₃N₂OCl: C, 70.1; H, 10.5; N, 6.8; Cl, 8.6; Found: C, 67.52; H, 10.73; N, 6.17; Cl, 8.17.

Preparation of N,N-Dimethyl-N-(3-lauramidopropyl)-N-benzylammonium Tetraphenylborate

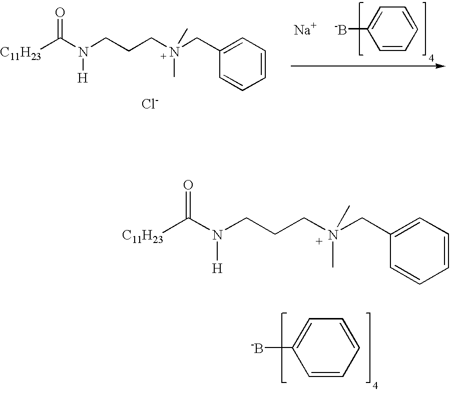

A solution of 1944.36 g (4.73 mol) of N,N-dimethyl-N-(3-lauramidopropyl)-N-benzylammonium chloride in 8 liters of water was added to a solution of 1618.84 g (4.73 mol) of sodium tetraphenylborate in 10 liters of water. The gummy solid which formed was dissolved in methylene chloride, and the resulting solution was dried over magnesium sulfate and concentrated. Ether was added to the residual oil, resulting in the formation of a solid that was collected and dried to give 2273.5 g (69.2% of theory) of product; mp 112-118° C.

Anal. Calcd. for C₄₈H₆₃N₂OB: C, 83.0; H, 9.1; N, 4.0; Found: C, 82.60; H, 9.20; N, 3.95.

Preparation of N-(3-Lauramidopropyl)trimethylammonium Iodide

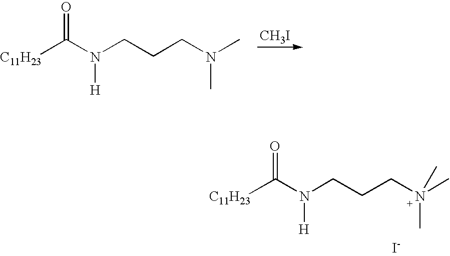

A solution of 30.0 g (0.105 mol) of N-(3-dimethylaminopropyl)lauramide, 15.0 g (0.105 mol) of methyl iodide, and 120 ml of acetone was prepared and cooled in a cold water bath to dissipate the heat of reaction. Within 10 mins, a white solid formed. The reaction mixture was allowed to stand for 5 hrs after removing the cooling bath. The solid was collected, washed with acetone and dried. The yield of product was 38.8 g (86.7% of theory).

Preparation of N-(3-Lauramidopropyl)trimethylammonium Tetraphenylborate

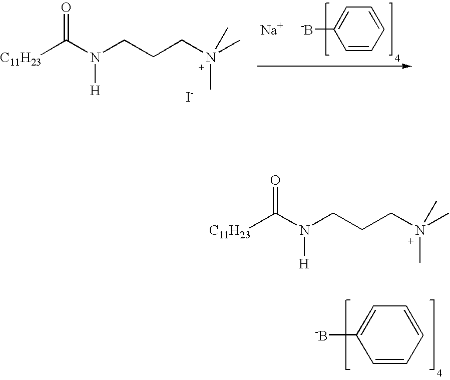

A solution of 38.8 g (0.091 mol) of N-(3-lauramidopropyl)trimethylammonium iodide in 150 ml of methanol and 31.15 g (0.091 mol) of sodium tetraphenylborate in 150 ml of water were combined with vigorous stirring. The resulting white precipitate was collected, washed with water, and recrystallized from a mixture of 600 ml of ethanol and 30 ml of acetonitrile. The solid was collected, washed with ethanol and dried. The yield of product was 46.2 g (82.1% of theory); mp 173-175° C.

Anal. C₄₂H₅₉N₂OB: C, 81.5; H, 9.6; N, 4.5; Found: C, 81.35; H, 9.73; N, 4.52.

Preparation of N,N-Dimethyl-N-octadecyl-N-(4-vinylbenzyl)ammonium Chloride

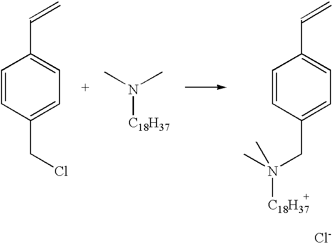

A mixture of 30.0 g (197 mmol) of 4-vinylbenzyl chloride and 58.4 g (197 mmol) of N,N-dimethyl-n-octadecylamine together with a small amount of t-butylpyrocatechol inhibitor in 200 ml of acetone was stirred overnight. Following the addition of 100 ml of acetone and stirring to break up the cake, the solid was collected, washed with acetone, and dried. The yield of product was 71.25 g (80.34% of theory); Tm 164.5° C. (by DSC).

Anal. Calcd for C₂₉H₅₂NCl: C, 77.38; H, 11.63; N, 3.11; Cl, 7.88; Found: C, 77.25; H, 11.71; N, 3.22; Cl, 6.94.

Preparation of N,N-Dimethyl-N-octadecyl-N-(4-vinylbenzyl)ammonium Tetraphenylborate

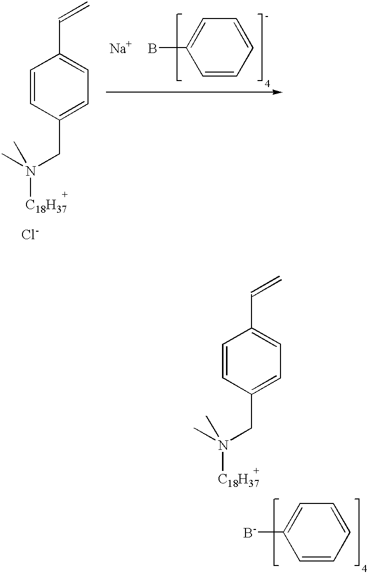

A solution of 22.51 g (50 mmol) of N,N-dimethyl-N-octadecyl-N-(4-vinylbenzyl)ammonium chloride in 500 ml of water was poured into a solution of 17.11 g (50 mmol) of sodium tetraphenylborate in 250 ml of water. The milky aqueous phase was removed from the white precipitate by decantation, and the precipitate was rinsed with water. The solid was recrystallized from acetonitrile, and the product was collected and dried. Yield: 8.37 g (22.8% of theory); mp 81-83° C.

Anal. Calcd. For C₅₃H₇₂NB: C, 86.7; H, 9.9; N, 1.9; B, 1.5; Found: C, 87.07; H, 9.96; N, 1.91; B, 1.6.

In a second preparation, a solution of 30.4 g (89 mmol) of sodium tetraphenylborate in 250 ml of water was added to a solution of 40.0 g (89 mmol) of N,N-dimethyl-N-octadecyl-N-(4-vinylbenzyl)ammonium chloride in 250 ml of methanol with vigorous stirring. The solid was collected, washed with ethanol, and recrystallized from 700 ml of 2:3 acetonitrile:ethanol. The solid was collected, washed with ethanol, and dried to give 49.75 g (76.3% of theory) of product; mp 82.5-84° C.

Anal Calcd. For C₅₃H₇₂NB: C, 86.7; H, 9.9; N, 1.9; B, 1.5; Found: C, 86.59; H, 9.81; N, 1.96; B, ND.

Preparation of Copoly[N,N-Dimethyl-N-octadecyl-N-(4-vinylbenzyl)ammonium

Tetraphenylborate: Isobutyl Methacrylate 10:90]

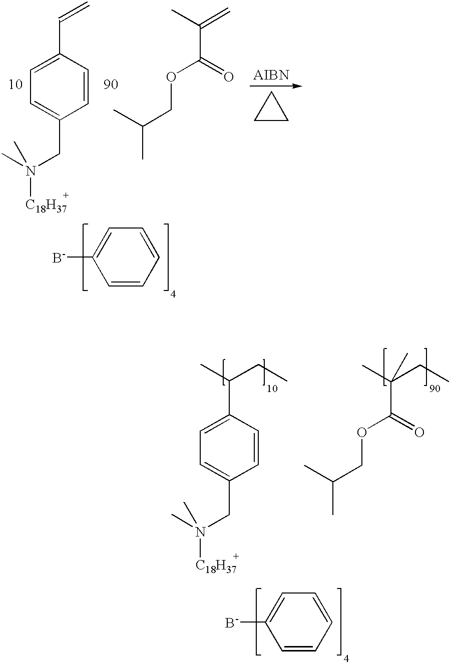

A solution of 5.00 g of N,N,-dimethyl-N-octadecyl-N-(4-vinylbenzyl)ammonium tetraphenylborate and 45.00 g of isobutyl methacrylate in 50.00 g of p-dioxane was purged with nitrogen in a 70° C. bath. To this solution was added 0.25 g of AIBN, and the resulting solution was heated at 70° C. overnight. The highly viscous solution was diluted with 50 ml of p-dioxane and poured into methanol, with stirring, to precipitate the polymer. The polymer was isolated, rinsed again with methanol, and redissolved in methylene chloride. The polymer was reprecipitated in methanol, collected, and dried. The yield of polymer was 28.2 g and had an inherent viscosity in methylene chloride (0.25 g/dl at 25° C.) of 0.66.

Preparation of N,N-Dimethyl-N-octadecyl-N-benzylammonium Tetraphenylborate

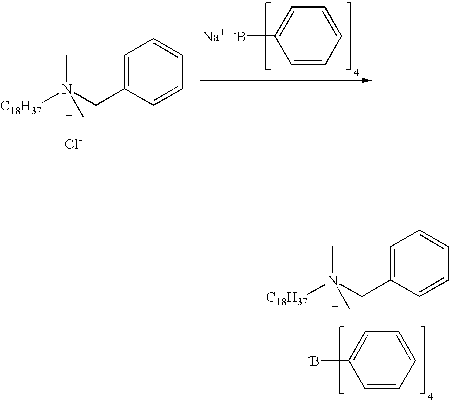

A solution of 42.42 g (0.10 mol) of N,N-dimethyl-N-octadecyl-N-benzylammonium chloride in 500 ml of water and a solution of 34.22 g (0.10 mol) of sodium tetraphenylborate in 150 ml of water were combined. The resulting white precipitate was collected and washed with ethanol. The crude product was recrystallized from 1500 ml of ethanol and 150 ml of acetonitrile, and the product was collected and dried. Yield: 58.0 g (81.9% of theory); mp 131.5-133° C.

Anal. Calcd. for C₅₁H₇₀NB: C, 86.5; H, 10.0; N, 2.0; B, 1.53; Found: C, 86.05; H, 10.14; N, 1.93; B, 1.69.

Preparation of N,N-Dimethyl-N-(2-Naphthylmethyl)-N-octadecylammonium Chloride

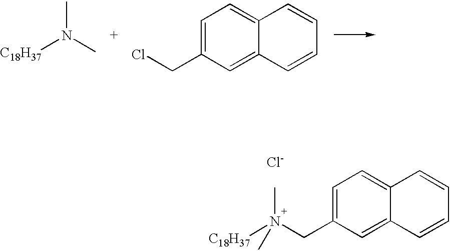

A mixture of 35.33 g (200 mmol) of 2-chloromethylnaphthalene, 59.51 g (200 mmol) of N,N-dimethyl-n-octadecylamine, and 200 ml of acetonitrile was heated at reflux (complete solution at reflux) for 5 hrs, then cooled. The white solid that crystallized was collected, washed with ether, and dried to give 83.7 g of product (88.3% of theory); mp 84-87° C.

Preparation of N,N-Dimethyl-N-(2-Naphthylmethyl)-N-octadecylammonium Tetraphenylborate

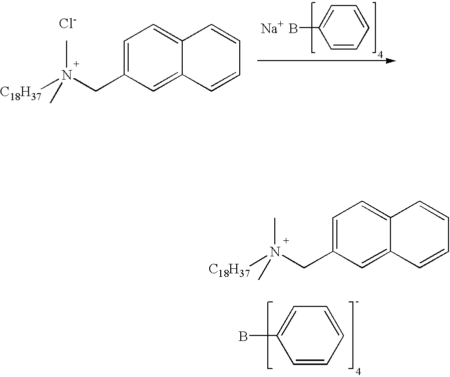

A solution of 47.42 g (100 mmol) of N,N-dimethyl-N-(2-naphthylmethyl)-N-octadecylammonium chloride in 100 ml of methanol was added, with stirring, to a solution of 34.23 g (100 mmol) of sodium tetraphenylborate in 150 ml of water. The white crystals that precipitated were collected, washed with water, and recrystallized from a mixture of 350 ml of ethanol and 800 ml of acetonitrile. The yield of product was 61.0 g (80 54% of theory); mp 168-170° C.

Anal. Calcd. For C₅₅H₇₂NB: C, 87.2; H, 9.6; N, 1.8; B, 1.43; Found: C, 87.84; H, 9.87; N, 2.04; B, 1.56

Preparation of 2-Dimethylaminoethyl Laurate

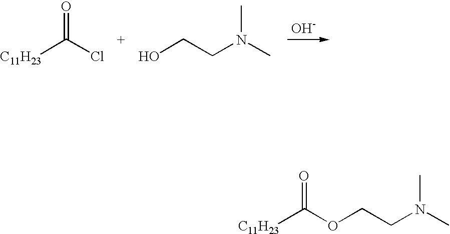

A solution of 87.51 g (400 mmol) of lauroyl chloride in 400 ml of methylene chloride was added to a solution of 35.66 g (400 mmol) of 2-dimethylaminoethanol and 16.00 g (400 mmol) of sodium hydroxide in 400 ml of water with rapid stirring over a 1 hour period. The mixture was stirred for another hour, and the organic layer was separated. The organic layer was washed twice with water, dried over magnesium sulfate, and concentrated. The NMR spectrum was consistent with the proposed structure.

Anal. Calcd. For C₁₆H₃₃NO₂: C, 70.22; H, 11.88; N, 3.95; Found: C, 70.47; H, 12.27; N, 4.00.

Preparation of N,N-Dimethyl-N-(2-lauroyloxyethyl)-N-benzylammonium Chloride

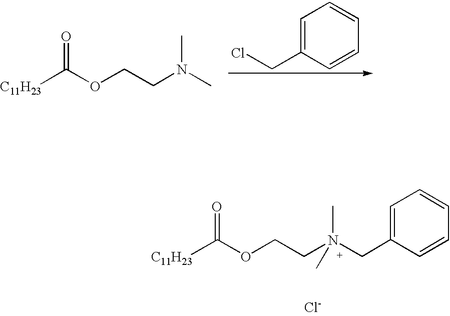

A solution of 39.55 g (146 mmol) of 2-dimethylaminoethyl laurate and 18.49 g (146 mmol) of benzyl chloride in 200 ml of acetone was stirred at room temperature overnight. The acetone was distilled off, and the crude material was used in the next step without further purification.

Preparation of N,N-Dimethyl-N-(-lauroyloxyethyl)-N-benzylammonium Tetraphenylborate

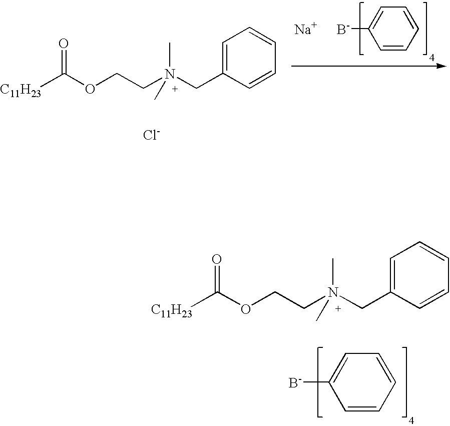

The crude N,N-dimethyl-N-(2-lauroyloxyethyl)-N-benzylammonium chloride, obtained as described in the preceding preparation was dissolved in 150 ml of methanol, and the resulting solution was poured into a filtered solution of 49.97 g (146 mmol) of sodium tetraphenylborate in 200 ml of water. The precipitate that formed was collected and dried to give 63.84 g of product; mp 133-135° C.

Anal. Calcd. For C₄₇H₆₀NO₂B: C, 82.80; H, 8.87; N, 2.05; B, 1.59; Found: C, 82.14; H, 8.90; N, 2.04; B, 1.61.

### Comparative Example I

A media milled dispersion was prepared from a mixture of 91.0 g of HOSTAPERM PINK™ pigment (manufactured by Hoechst Celanese) and 9.0 g of commercially available styrene-butyl acrylate polymer (PICCOTONER 1221™) in 670.0 g of ethyl acetate (13.0% solids of mixture). To 37.0 g of the above media milled dispersion were then added 20.2 g of KAO C™ binder and 26.2 g of ethyl acetate. This mixture, consisting of 17.5% pigment and 82.5% binder, provided the organic phase for an evaporative limited coalescence process. The organic phase was mixed with an aqueous phase comprising 85 ml of pH4 buffer containing 14.5 g of NALCO® 1060 and 3.2 ml of 10% poly(adipic acid-comethylaminoethanol). This mixture was then subjected to very high shear using a POLYTRON™, sold by Brinkman, followed by a Microfluidizer. The liquid phase was removed from the particles so formed by stirring overnight at room temperature in an open container. The particles were washed with 0.1N potassium hydroxide solution to remove the silica, then washed with water and dried. The toner particles were of the order of 4.2μ volume average and entirely spherical, as revealed by microscopic examination, with BET number of 0.90 m²/g.

### Comparative Example II

The procedure of Comparative Example I was repeated with the exception that 10.0% of a mixture of Bridged Aluminum Phthalocyanine and Copper Phthalocyanine pigments, manufactured by Eastman Kodak and BASF, respectively, replaced the HOSTAPERM PINK™ pigment. The resultant particles were spherical, and particle size was 4.0μ, with BET number of 0.60 m²/g.

### Comparative Example III

The procedure of Comparative Example I was repeated with the exception that the HOSTAPERM PINK™ pigment was replaced by 10.0% PIGMENT YELLOW 180™, manufactured by BASF. The resultant particles were spherical, and particle size was 3.6μ, with BET number of 0.95 m²/g.

### Comparative Example IV

The procedure of Comparative Example I was repeated with the exception that the HOSTAPERM PINK™ pigment was replaced by 8.0% carbon black, BLACK PEARLS 280™, manufactured by Cabot. The resultant particles were completely spherical, and particle size was 4.9μ, with BET number of 0.50 m²/g.

### Example 1

To 37.0 g of the HOSTAPERM PINK™ media milled dispersion were added 20.2 g of KAO™ C binder, 0.25 g of Compound 1, and 26.2 g of ethyl acetate. This mixture, containing 17.5% pigment and 82.5% binder, comprised the organic phase in the evaporative limited coalescence process. The organic phase was mixed with an aqueous phase comprising 85 ml of pH4 buffer containing 14.5 g of NALCO® 1060 and 3.2 ml of 10% poly (adipic acid-comethylaminoethanol). This mixture was then subjected to very high shear using a POLYTRON™ sold by Brinkman, followed by a Microfluidizer. Upon exiting, the liquid phase was removed from the particles so formed by stirring overnight at room temperature in an open container. These particles were washed with 0.1N potassium hydroxide solution to remove the silica, then washed with water and dried. The toner particles, which contained 1.0 weight % of Compound 1, were of the order of 3.6μ volume average and entirely non-spherical, with BET number of 2.20 m²/g.

### Example 2

The procedure of Example 1 was repeated with the exception that Compound 1 was replaced by 0.25 g of Compound 2. The resultant toner particles, which contained 1.0 weight % of Compound 2, were completely non-spherical, and particle size was 3.9μ, with BET number of 2.66 m²/g.

### Example 3

The procedure of Example 1 was repeated with the exception that magenta pigment was replaced with 10.0% BrAlPc/CuPc cyan pigment. The resultant particles were completely non-spherical, and particle size was 5.0μ, with BET number of 1.80 m²/g.

### Example 4

The procedure of Example 2 was repeated with the exception that magenta pigment was replaced with 10.0% BrAlPc/CuPc cyan pigment. The resultant particles were completely non-spherical, and particle size was 3.5μ, with BET number of 2.38 m²/g.

### Example 5

The procedure of Example 1 was repeated with the exception that magenta pigment was replaced with 10.0% PIGMENT YELLOW 180™. The resultant particles were completely non-spherical, and particle size was 3.6μ, with BET number of 1.59 m²/g.

### Example 6

The procedure of Example 2 was repeated with the exception that magenta pigment was replaced with 10.0% PIGMENT YELLOW 180™. The resultant particles were completely non-spherical,and particle size was 3.7μ, with BET number of 1.95 m²/g.

### Example 7

The procedure of Example 1 was repeated with the exception that magenta pigment was replaced with 8.0% carbon black (BLACK PEARLS 280™). The resultant particles were completely non-spherical, and particle size was 3.9μ, with BET number of 1.03 m²/g.

### Example 8

The procedure of Example 2 was repeated with the exception that magenta pigment was replaced with 8.0% carbon black (BLACK PEARLS 280™). The resultant particles were completely non-spherical, and particle size was 3.6μ, with BET number of 2.16 m²/g.

### Example 9

To 21.1 g of the PIGMENT YELLOW 180™ media milled dispersion were added 22.3 g of KAO C™ binder, 0.25 g of Compound 5, and 26.2 g of ethyl acetate. This mixture, containing 10.0% pigment and 90.0% binder, comprised the organic phase in the evaporative limited coalescence process. The organic phase was mixed with an aqueous phase comprising 85 ml of pH4 buffer containing 12.5 g of NALCO® 1060 and 2.7 ml of 10% poly (adipic acid-comethylaminoethanol). This mixture was then subjected to very high shear using a POLYTRON™ sold by Brinkman, followed by a Microfluidizer. Upon exiting, the liquid phase was removed from the particles so formed by stirring overnight at room temperature in an open container. The particles were washed with 0.1N potassium hydroxide solution to remove the silica, then washed with water and dried. The toner particles, which contained 1.0 weight % of Compound 5, were of the order of 3.6μ volume average and entirely non-spherical, with BET number of 1.03 m²/g.

### Example 10

The procedure of Example 9 was repeated with the exception that Compound 5 was replaced with 0.25 g of Compound 6. The resultant particles, which contained 1.0 weight % of Compound 6, were completely non-spherical, and particle size was 3.6μ, with BET number of 1.49 m²/g.

### Example 11

The procedure of Example 9 was repeated with the exception that Compound 5 was replaced with 0.25 g of Compound 7. The resultant particles, which contained 1.0 weight % of Compound 7, were completely non-spherical, and particle size was 3.7μ, with BET number of 1.27 m²/g.

### Example 12

The procedure of Example 9 was repeated with the exception that Compound 5 was replaced with 0.25 g of Compound 9. The resultant particles, which contained 1.0 weight % of Compound 9, were completely non-spherical, and particle size was 3.6μ, with BET number of 1.12 m²/g.

### Example 13

The procedure of Example 9 was repeated with the exception that Compound 5 was replaced with 0.25 g of Compound 8. The resultant particles, which contained 1.0 weight % of Compound 8, were completely non-spherical, and particle size was 3.7μ, with BET number of 1.22 m²/g.

### Example 14

To 37.0 g of the HOSTAPERM PINK™ media milled dispersion were then added 20.2 g of KAO C™ binder, 0.25 g of Compound 1, 0.75 g of Compound 13 and 26.2 g of ethyl acetate. This mixture, containing 17.5% pigment and 82.5% binder, comprised the organic phase in the evaporative limited coalescence process. The organic phase was mixed with an aqueous phase comprising 85 ml of pH4 buffer containing 14.5 g of NALCO® 1060 and 3.2 ml of 10% poly (adipic acid-comethylaminoethanol). This mixture was then subjected to very high shear using a POLYTRON™ sold by Brinkman, followed by a Microfluidizer. Upon exiting, the liquid phase was removed from the particles so formed by stirring overnight at room temperature in an open container. These particles were washed with 0.1N potassium hydroxide solution to remove the silica, then washed with water and dried. The toner particles, which contained 1.0 weight % of Compound 1 and 3.0 weight % of Compound 13, were of the order of 3.5μ volume average and entirely non-spherical, with BET number of 2.23 m²/g.

### Example 15

The procedure of Example 14 was repeated with the exception that magenta pigment was replaced with 10.0% BrAlPc/CuPc cyan pigment. The resultant particles were completely non-spherical, and particle size was 3.8μ, with BET number of 1.99 m²/g.

### Example 16

The procedure of Example 14 was repeated with the exception that magenta pigment was replaced with 10.0% PIGMENT YELLOW 180™. The resultant particles were completely non-spherical, and particle size was 4.3μ, with BET number of 1.93 m²/g.

### Example 17

The procedure of Example 14 was repeated with the exception that magenta pigment was replaced with 8.0% carbon black (BLACK PEARLS 280™). The resultant particles were completely non-spherical, and particle size was 3.8μ, with BET number of 1.26 m²/g.

### Example 18

To 21.1 g of the PIGMENT YELLOW 180™ media milled dispersion were then added 21.8 g of KAO C™ binder, 0.25 g of Compound 1, 0.75 g of Compound 14, and 26.2 g of ethyl acetate. This mixture, containing 10.0% pigment and 90.0% binder, comprised the organic phase in the evaporative limited coalescence process. The organic phase was mixed with an aqueous phase comprising 85 ml of pH4 buffer containing 12.5 g of NALCO® 1060 and 2.7 ml of 10% poly (adipic acid-comethylaminoethanol). This mixture was then subjected to very high shear using a POLYTRON™ sold by Brinkman, followed by a Microfluidizer. Upon exiting, the liquid phase was removed from the particles so formed by stirring overnight at room temperature in an open container. The particles were washed with 0.1N potassium hydroxide solution to remove the silica, then washed with water and dried. The toner particles, which contained 1.0 weight % of Compound 1 and 3.0 weight % of Compound 14, were of the order of 3.9μ volume average and entirely non-spherical, with BET number of 1.19 m²/g.

### Example 19

The procedure of Example 18 was repeated with the exception that Compound 14 was replaced with 0.75 g of Compound 15. The resultant particles, which contained 1.0 weight % of Compound 1 and 3.0 weight % of Compound 15, were completely non-spherical, and particle size was 4.0μ, with BET number of 1.44 m²/g.

### Example 20

The procedure of Example 18 was repeated with the exception that Compound 14 was replaced with 0.75 g of Compound 16. The resultant particles, which contained 1.0 weight % of Compound 1 and 3.0 weight % of Compound 16, were completely non-spherical, and particle size was 3.8μ, with BET number of 1.35 m²/g.

### Example 21

To 37.0 g of the HOSTAPERM PINK™ media milled dispersion were then added 20.2 g of KAO C™ binder, 0.25 g of Compound 14, 0.25 g of Compound 10, and 26.2 g of ethyl acetate. This mixture, containing 17.5% pigment and 82.5% binder, comprised the organic phase in the evaporative limited coalescence process. The organic phase was mixed with an aqueous phase comprising 85 ml of pH4 buffer containing 14.5 g of NALCO® 1060 and 3.2 ml of 10% poly(adipic acid-comethylaminoethanol). This mixture was then subjected to very high shear using a POLYTRON™ sold by Brinkman, followed by a Microfluidizer. Upon exiting, the solvent was removed from the particles so formed by stirring overnight at room temperature in an open container. The particles were washed with 0.1N potassium hydroxide solution to remove the silica, then washed with water and dried. The toner particles, which contained 1.0 weight % each of Compound 14 and Compound 10, were of the order of 3.7μ volume average and entirely non-spherical, with BET number of 2.31 m²/g.

### Example 22

The procedure of Example 21 was repeated with the exception that Compound 10 was replaced with 0.25 g of Compound 11. The resultant particles, which contained 1.0 weight % each of Compound 14 and Compound 11, were completely non-spherical, and particle size was 3.5μ, with BET number of 2.24 m²/g.

### Example 23

The procedure of Example 21 was repeated with the exception that magenta pigment was replaced with 10.0% BrAlPc/CuPc cyan pigment. The resultant particles were completely non-spherical, and particle size was 3.7μ, with BET number of 1.34 m²/g.

### Example 24

The procedure of Example 22 was repeated with the exception that magenta pigment was replaced with 10.0% BrAlPc/CuPc cyan pigment. The resultant particles were completely non-spherical, and particle size was 3.6μ, with BET number of 2.21 m²/g.

### Example 25

The procedure of Example 21 was repeated with the exception that magenta pigment was replaced with 10.0% PIGMENT YELLOW 180™. The resultant particles were completely non-spherical, and particle size was 4.0μ, with BET number of 1.75 m²/g.

### Example 26

The procedure of Example 22 was repeated with the exception that magenta pigment was replaced with 10.0% PIGMENT YELLOW 180™. The resultant particles were completely non-spherical, and particle size was 3.9μ, with BET number of 1.55 m²/g.

### Example 27

The procedure of Example 21 was repeated with the exception that magenta pigment was replaced with 8.0% carbon black (BLACK PEARLS 280™). The resultant particles were completely non-spherical, and particle size was 3.6μ, with BET number of 1.08 m²/g.

BET Measurements

BET measurements of comparison toner particles and toner particles of the present invention were carried out using Single Point Monosorb® BET apparatus, from Quantachrome Corporation. The results, compiled in Table 5 below, demonstrate the control of toner morphology provided by the present invention. A BET value of 1.00 m²/g or less is indicative of sphericity in the shape of the toner particles, as is illustrated in Comparative Examples I, II, III, and IV. BET values were calculated according to P. Chenebault et al., “The Measurement of Small Surface Areas by the B.E.T. Adsorption Method”, The Journal of Physical Chemistry, Vol. 69, No. 7, 1965, pp 2300-2305.

TABLE 5

| | Pigment | | |
|---|---|---|---|
| Example | Color | Particle Size (μ) | BET Value (m²/g) |
| Comparative I | magenta | 4.2 | 0.90 |
| Comparative II | cyan | 4.0 | 0.60 |
| Comparative III | yellow | 3.6 | 0.95 |
| Comparative IV | black | 4.9 | 0.50 |
| Example 1 | magenta | 3.6 | 2.20 |
| Example 2 | magenta | 3.9 | 2.66 |
| Example 3 | cyan | 5.0 | 1.80 |
| Example 4 | cyan | 3.5 | 2.38 |
| Example 5 | yellow | 3.6 | 1.59 |
| Example 6 | yellow | 3.7 | 1.95 |
| Example 7 | black | 3.9 | 1.03 |
| Example 8 | black | 3.6 | 2.16 |
| Example 9 | yellow | 3.6 | 1.03 |
| Example 10 | yellow | 3.6 | 1.49 |
| Example 11 | yellow | 3.7 | 1.27 |
| Example 12 | yellow | 3.6 | 1.12 |
| Example 13 | yellow | 3.7 | 1.22 |
| Example 14 | magenta | 3.5 | 2.23 |
| Example 15 | cyan | 3.8 | 1.99 |
| Example 16 | yellow | 4.3 | 1.93 |
| Example 17 | black | 3.8 | 1.26 |
| Example 18 | yellow | 3.9 | 1.19 |
| Example 19 | yellow | 4.0 | 1.44 |
| Example 20 | yellow | 3.8 | 1.35 |
| Example 21 | magenta | 3.7 | 2.31 |
| Example 22 | magenta | 3.5 | 2.24 |
| Example 23 | cyan | 3.7 | 1.34 |
| Example 24 | cyan | 3.6 | 2.21 |
| Example 25 | yellow | 4.0 | 1.75 |
| Example 26 | yellow | 3.9 | 1.55 |
| Example 27 | black | 3.6 | 1.08 |

As shown by examination of the BET measurements in Table 5 above, inclusion of at least one tetraphenylborate salt in magenta, cyan, yellow, and black toner particles formed in accordance with the present invention resulted in a substantial beneficial reduction in their sphericity characteristics relative to the corresponding Comparative particles I, II, III, and IV.

Charge Control Properties

Charge control properties provided by tetraphenylborate quaternary salts in accordance with the present invention are tabulated in Table 6 below. The triboelectric charge of electrophotographic developers changes with life. This instability in charging level is one of the factors that require active process control systems in electrophotographic printers to maintain consistent print to print image density. Developers with low charge/mass (Q/m) have good stability and provide the capability for improved electrostatic transfer and consequent higher densities. Q/m values are dependent on particle size; for toners of a particular composition, the smaller the particle, the higher the absolute Q/m value. A desirable lowering of the absolute Q/m of toner particles is provided by the present invention.

TABLE 6

| | | | New Developer | | Strip and Rebuild | |
|---|---|---|---|---|---|---|
| | Pigment | Particle | 10BB | | 10BB | |
| Example | Color | Size (μ) | Q/m | % TC | Q/m | % TC |
| Comparative I | magenta | 4.2 | −74 | 6.0 | −93 | 6.0 |
| Comparative II | cyan | 4.0 | −156 | 5.0 | −175 | 5.2 |
| Comparative III | yellow | 3.6 | −151 | 5.3 | −178 | 5.4 |
| Comparative IV | black | 4.9 | −86 | 5.7 | −86 | 6.0 |
| Example 1 | magenta | 3.6 | −100 | 5.6 | −121 | 5.5 |
| Example 2 | magenta | 3.9 | −49 | 6.0 | −39 | 6.0 |
| Example 3 | cyan | 5.0 | −95 | 5.6 | −99 | 5.9 |
| Example 4 | cyan | 3.5 | −80 | 6.0 | −80 | 6.0 |
| Example 5 | yellow | 3.6 | −104 | 5.7 | −136 | 6.0 |
| Example 6 | yellow | 3.7 | −86 | 5.6 | −98 | 5.9 |
| Example 7 | black | 3.9 | −141 | 5.3 | −148 | 5.8 |
| Example 8 | black | 3.6 | −73 | 5.5 | −79 | 5.9 |
| Example 9 | yellow | 3.6 | −106 | 5.9 | −119 | 5.6 |
| Example 10 | yellow | 3.6 | −77 | 5.7 | −69 | 5.9 |
| Example 11 | yellow | 3.7 | −121 | 5.1 | −111 | 5.6 |
| Example 12 | yellow | 3.6 | −114 | 6.1 | −137 | 5.7 |
| Example 13 | yellow | 3.7 | −149 | 5.4 | −111 | 5.9 |
| Example 14 | magenta | 3.5 | −101 | 5.4 | −102 | 5.7 |
| Example 15 | cyan | 3.8 | −108 | 5.2 | −116 | 5.6 |
| Example 16 | yellow | 4.3 | −54 | 6.0 | −69 | 6.0 |
| Example 17 | black | 3.8 | −121 | 5.7 | −131 | 5.7 |
| Example 18 | yellow | 3.9 | −101 | 5.5 | −104 | 6.1 |
| Example 19 | yellow | 4.0 | −47 | 5.7 | −52 | 6.1 |
| Example 20 | yellow | 3.8 | −79 | 5.7 | −83 | 6.0 |
| Example 21 | magenta | 3.7 | −65 | 5.5 | −73 | 5.9 |
| Example 22 | magenta | 3.5 | −62 | 5.4 | −60 | 5.9 |
| Example 23 | cyan | 3.7 | −97 | 5.5 | −78 | 5.8 |
| Example 24 | cyan | 3.6 | −65 | 5.7 | −53 | 5.5 |
| Example 25 | yellow | 4.0 | −75 | 5.8 | −78 | 6.0 |
| Example 26 | yellow | 3.9 | −76 | 5.6 | −77 | 6.0 |
| Example 27 | black | 3.6 | −151 | 5.2 | −135 | 5.9 |

Measurement of the charge/mass (Q/m) characteristics of the toner particles listed in Table 6 were made using the “Bottle Brush” apparatus, as described in U.S. Pat. No. 5,405,727, the disclosure of which is incorporated herein by reference. The toners were tested for tribocharging by the following procedure:

Two-component developers are prepared at 6% by weight toner concentration. The carrier is obtained from PowderTech Corp., and comprises a permanently magnetized strontium ferrite core coated with 2% by weight of silicone resin. Four-gram samples of each developer are weighed into vials, which are subjected to 10 minutes of exercise on the Bottle Brush apparatus. The charge per mass (Q/m) of the developers is measured on a MECCA device comprising metal plates spaced 1 cm apart by insulating pegs, with a 60 Hz magnetic coil under the bottom plate. The bottom plate is biased to −2000V; the upper plate is connected to a coulombmeter; the toner deposit collected on the upper plate is weighed and Q/m is calculated as the ratio of the measured charge divided by the weight of toner developed. Table 5 lists the values so obtained as “New Developer 10BB” Q/m. The test comprises mounting the sample vial on top of a magnetic brush with an internal rotating magnetic core operating at 2000 rpm for 10 minutes. The magnetic core consists of 12 magnetic poles arranged in an alternating north, south fashion.

The vial is subsequently placed on the Bottle Brush apparatus and exercised for an additional 50 minutes. After this additional 50 minutes exercising, the developer is stripped of all toner and rebuilt with fresh toner at 6% TC, and Q/m is measured as described above, the results being entered in the column captioned “Strip and Rebuild 10BB.”

As shown by examination of the Q/m measurements in Table 6 above, inclusion of at least one tetraphenylborate salt in magenta, cyan, yellow, and black toner particles formed in accordance with the present invention provides, in addition to a desirable effect on particle shape, a substantial beneficial reduction in the absolute Q/m of toner particles, in particular, cyan and yellow toners, relative to Comparative particles II and III.

The invention has been described in detail with particular reference to certain preferred embodiments thereof, but it is understood that variations and modifications can be effected within the spirit and scope of the invention, which is defined by the claims that follow.

What is claimed is:

1. A process for lowering the charge/mass (Q/m) ratio of toner particles formed by limited coalescence, said process comprising:
forming an organic phase comprising a polymeric material, a pigment, a quaternary ammonium tetraphenylborate salt, and a water-immiscible liquid, said polymeric material being selected from the group consisting of an acrylic resin, a methacrylic resin, a styrene-acrylic resin, a styrene-methacrylic resin, a polyamide, and a polyester;
dispersing said organic phase in an aqueous phase containing a solid colloidal stabilizer;
forming a suspension of small droplets of said organic phase in said aqueous phase by high shear agitation;
removing said water-immiscible liquid from said small droplets, thereby forming a suspension of small solid particles in said aqueous phase, said particles having a non-spherical shape; and
separating said solid particles from said aqueous phase and drying said particles,
wherein said quaternary ammonium tetraphenylborate salt is included in said organic phase in an amount effective for lowering the charge/mass (Q/m) ratio of said toner particles, said quaternary ammonium tetraphenylborate salt being selected from the group consisting of salts represented by the general formulas (I), (II), (III), and (IV), and mixtures thereof: 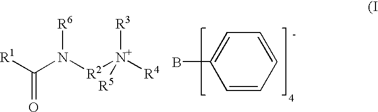
wherein R¹ represents a substituted or unsubstituted alkyl or aryl group; R² represents an alkylene or arylene group; R³, R⁴, and R⁵ independently represent a substituted or unsubstituted alkyl group, and R³ and R⁴ taken together may form a cyclic ring system; and R⁶ represents hydrogen or a substituted or unsubstituted alkyl group; 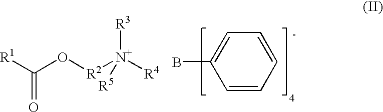
wherein R¹ represents a substituted or unsubstituted alkyl or aryl group; R² represents an alkylene or arylene group; R³, R⁴ and R⁵ each independently represents a substituted or unsubstituted alkyl group; and R³ and R⁴ taken together may form a cyclic ring system;. 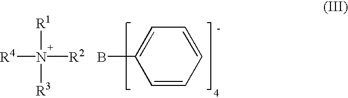
wherein R¹, R², R³ and R⁴ each independently represents an alkyl or substituted alkyl group, and R¹ and R² taken together may form a cyclic ring system; 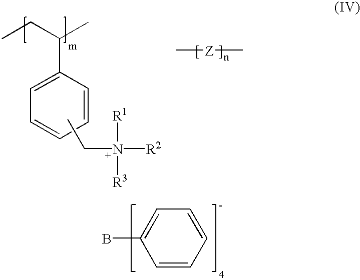
wherein R¹, R² and R³ each independently represents an alkyl or substituted alkyl group and R¹ and R² taken together may form a cyclic ring structure; Z, if present, represents at least one monomer copolymerizable with a monomer comprising a tetraphenylborate salt substituent; m and n represent the weight percentages in a polymerization mixture of, respectively, said monomer comprising a tetraphenylborate salt substituent and Z, m and n together totaling 100.

2. The process of claim 1 wherein said polymeric material comprises a styrene-acrylic resin.

3. The process of claim 2 wherein said styrene-acrylic resin is a styrene-butyl acrylate resin.

4. The process of claim 1 wherein, in general formula (I), R¹ is selected from the group consisting of methyl, ethyl, n-propyl, n-butyl, hexyl, undecyl, heptadecyl, phenyl, 4-methylphenyl, and 4-t-butylphenyl; R² is selected from the group consisting of ethylene, 1,3-propylene, 1,4-butylene, hexamethylene, and p-phenylene; R³, R⁴, and R⁵ are each independently selected from the group consisting of methyl, ethyl, n-propyl, octadecyl, and benzyl, and R³ and R⁴ taken together may be 1,4-butylene or 1,5-pentylene, and R⁶ is selected from the group consisting of hydrogen, methyl, ethyl, n-propyl, n-butyl, octadecyl, and benzyl.

5. The process of claim 4 wherein R¹ is undecyl, R² is 1,3-propylene, R³ and R⁴ are each methyl, R⁵ is benzyl, and R⁶ is hydrogen.

6. The process of claim 1 wherein, in general formula (II), R¹ is selected from the group consisting of methyl, ethyl, n-propyl, n-butyl, hexyl, undecyl, heptadecyl, phenyl, 4-methylphenyl, and 4-t-butylphenyl; R² is selected from the group consisting of ethylene, 1,3-propylene, 1,4-butylene, hexamethylene, and p-phenylene; R³, R⁴ and R⁵ are each independently selected from the group consisting of methyl, ethyl, n-propyl, octadecyl, and benzyl, and R³ and R⁴ taken together may be 1,4-butylene or 1,5-pentylene.

7. The process of claim 6 wherein R¹ is undecyl or phenyl, R² is 1,3-propylene, R³ and R⁴ are each methyl, and R⁵ is benzyl.

8. The process of claim 1 wherein, in general formula (III), R¹, R², R³ and R⁴ are each independently selected from the group consisting of methyl, ethyl, n-propyl, isopropyl, n-butyl, t-butyl, pentyl, hexyl, 2-ethylhexyl, heptyl, octyl, decyl, octadecyl, benzyl, and 2-naphthylmethyl, and R¹ and R² taken together may be 1,4-butylene or 1,5-pentylene.

9. The process of claim 8 wherein R¹ and R² are each methyl, R³ is octadecyl, R⁴ is 2-naphthylmethyl.

10. The process of claim 1 wherein, in general formula (IV), R¹, R², and R³ are each independently selected from the group consisting of methyl, ethyl, n-propyl, isopropyl, n-butyl, iso-butyl, t-butyl, octyl, octadecyl, and benzyl.

11. The process of claim 10 wherein R¹ is octadecyl, R² and R³ are each methyl.

12. The process of claim 1 wherein, in general formula (IV), the value of m is from 0.01 to 100.

13. The process of claim 12 wherein m is about 10 and n is about 90.

14. The process of claim 1 wherein, in general formula (IV), Z is selected from the group consisting of isobutyl methacrylate, isobutyl acrylate, methyl methacrylate, methyl acrylate, styrene, 4-t-butylstyrene, methyl vinyl ether, acrylamide, methacrylamide, and mixtures thereof.

15. The process of claim 14 wherein Z is isobutyl methacrylate.

16. The process of claim 1 wherein said quaternary ammonium tetraphenylborate salt comprises about 0.1 to about 10 weight percent of total solids.

17. The process of claim 1 wherein said pigment is included in a dispersion.

18. The process of claim 1 wherein said pigment is a cyan-colored pigment or a yellow-colored pigment.

19. The process of claim 1 wherein said water-immiscible liquid is selected from the group consisting of dichloromethane, ethyl acetate, methyl ethyl ketone, and mixtures thereof.

20. The process of claim 1 wherein said solid colloidal stabilizer comprises silicon dioxide.

21. The process of claim 1 wherein said aqueous phase has a pH of about 2 to about 7.

22. The process of claim 21 wherein said aqueous phase has a pH buffered to about 4.

23. The process of claim 1 wherein said non-spherical toner particles have a volume-average particle size of about 3.5μ to about 5μ.

24. The process of claim 1 wherein said said quaternary ammonium tetraphenylborate is selected from the salts listed in Tables 1, 2, 3, and 4 below
TABLE 1

| | |
|---|---|
| | I |
| 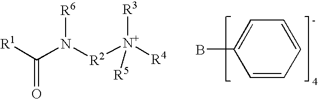 | |
| Compound | R¹ | R² | R³ | R³ | R⁵ | R⁶ |
|---|---|---|---|---|---|---|
| 1 | C₁₁H₂₃ | CH₂CH₂CH₂ | CH₃ | CH₂C₆H₅ | CH₃ | H |
| 2 | C₁₁H₂₃ | CH₂CH₂CH₂ | CH₃ | CH₃ | CH₃ | H |
| 3 | C₅H₁₁ | CH₂CH₂CH₂ | CH₃ | CH₂C₆H₅ | CH₃ | H |
| 4 | C₁₁H₂₃ | CH₂CH₂ | CH₃ | CH₂C₆H₅ | CH₃ | H |

TABLE 2

| | |
|---|---|
| | II |
| 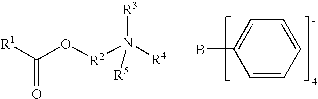 | |
| Compound | R¹ | R² | R³ | R⁴ | R⁵ |
|---|---|---|---|---|---|
| 5 | C₁₁H₂₃ | CH₂CH₂ | CH₃ | CH₂C₆H₅ | CH₃ |
| 6 | C₁₁H₂₃ | CH₂CH₂ | CH₃ | CH₃ | CH₃ |
| 7 | C₁₁H₂₃ | CH₂CH₂CH₂ | CH₃ | CH₂C₆H₅ | CH₃ |
| 8 | C₆H₅ | CH₂CH₂CH₂ | CH₃ | CH₃ | CH₃ |
| 9 | C₆H₅ | CH₂CH₂CH₂ | CH₃ | CH₂C₆H₅ | CH₃ |

TABLE 3

| | |
|---|---|
| | (III) |
| 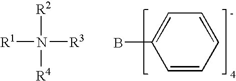 | |
| Compound | R¹ | R² | R³ | R⁴ |
|---|---|---|---|---|
| 10 | CH₃ | CH₃ | C₁₈H₃₇ | CH₂C₆H₅ |
| 11 | CH₃ | CH₃ | C₁₈H₃₇ | C₁₈H₃₇ |
| 12 | CH₃ | CH₃ | C₁₈H₃₇ | 2-naphthyl- |
| | | | | CH₂ |

TABLE 4

| | | | | | | | | (IV) |
|---|---|---|---|---|---|---|---|---|
| 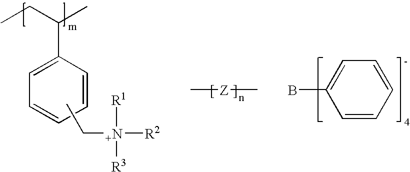 | | | | | | | | |
| | | | | | m | n | | |
| Compound | R¹ | R² | R³ | Z | (wt %) | (wt %) | IV(DCM) | Tg, C |
| | | | | 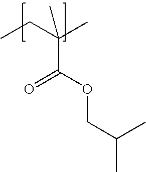 | | | | |
| 13 | CH₃ | C₁₈H₃₇ | CH₃ | | 10 | 90 | 0.66 | 59.5 |
| 14 | CH₃ | CH₂C₆H₅ | CH₃ | | 10 | 90 | 0.45 | 67.5 |
| 15 | CH₃ | C₄H₉ | CH₃ | | 10 | 90 | 0.55 | 66.6 |
| 16 | CH₃ | C₈H₁₇ | CH₃ | | 10 | 90 | 0.48 | 65.4 |

or mixtures of salts in said Tables, wherein the salts listed in Tables 1, 2, 3, and 4 are represented by, respectively, structures (I), (II), (III), and (IV).
